(19) United States
(12) Patent Application Publication
(10) Pub. No.: US 2026/0319757 A1
(43) Pub. Date: Oct. 15, 2026

(54) IOT DEVICE CONFIGURATION TOOL

(71) Applicant: Trident IoT, LLC, Carlsbad, CA (US)

(72) Inventor: Serge Poltorak, Geneva (CH)

(21) Appl. No.: 19/438,327

(22) Filed: Dec. 31, 2025

Related U.S. Application Data
(60) Provisional application No. 63/740,784, filed on Dec. 31, 2024.

(51) Int. Cl. G06F 8/30; G06F 3/0482

(52) U.S. Cl. CPC G06F 8/30; G06F 3/0482

(57) ABSTRACT

A system, method and apparatus is described for quickly developing new IoT products. A client computer displays in interface allowing a user to configure a particular IoT device with peripheral hardware and to generate customized source code for controlling the particular IoT device. The interface allows the user to apply a number of attributes, such as pin setup information, associations and logic to the customized source code for producing a customized, new, IoT product.

### BACKGROUND

### I. Cross-reference to Related Applications

This application claims the benefit of U.S. provisional patent application 63/740,784 filed on Dec. 31, 2024.

### II. Field of Use

The present invention relates to the field of electrical engineering and, more specifically, the design of Internet-of-Things (IoT) devices.

### III. Description of the Related Art

The Internet-of-Things (“IoT”) is a term of art that describes the recent proliferation of small, battery-powered electronic devices, such as smart vacuum cleaners, smart toothbrushes, wireless security sensors, wireless environmental sensors, wireless HVAC sensors, wireless power sensors, wireless water sensors, wireless temperature sensors, etc. Such IoT devices typically utilize wireless, low-power communication technology and protocols, such as Z-Wave, Zigbee, Thread, Matter, Bluetooth, etc.

One of the challenges of developing such IoT devices is for engineers to learn the intricacies of each wireless protocol. The protocols can be complex and difficult to learn. Moreover, technology is increasing at such a rapid pace that once a protocol has been mastered, different protocol may arise to take its place, requiring engineers to again face a steep learning curve. All of this is time consuming and costly.

### SUMMARY

The embodiments herein describe a system, method and apparatus for quickly developing new IoT products. In one embodiment, a method is described, comprising receiving user selection of an IoT device type, receiving pin setup information associated with a shield used in association with an IoT wireless module, and automatically generating source code based on the selected IoT device type and the pin setup information for causing the IoT wireless module to control functions of the selected IoT product.

In another embodiment, a server is described for quickly developing new IoT products, comprising a memory for storing processor-executable instructions a network interface, and a processor coupled to the memory and to the network interface for executing the processor-executable instructions that causes the server to receive user selection of an IoT device type, receive pin setup information associated with a shield used in association with an IoT wireless module and automatically generate source code based on the selected IoT device type and the pin setup information for causing the IoT wireless module to control functions of the selected IoT product.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a screenshot of a webpage displaying one embodiment of an interface to a software-based, IoT configuration tool;

FIG. 2 is the same screenshot as shown in FIG. 1, except that one of several PWM outputs has been selected as a digital output for controlling an AC switch;

FIG. 3 is a source code listing that may be automatically generated as a user selects and configures various inputs and outputs of the shield shown in FIGS. 1 and 2;

FIG. 4 is a screenshot of a webpage displaying the interface to software-based, IoT configuration tool as shown in FIGS. 1-3, except that none of the digital PWM outputs are being used, two of four ADC I/O's are being used to read two voltages of a reed switch of a door/window sensor and a tilt switch, respectfully, and a third ADC I/O is being used as a digital output for controlling light bulbs via a light switch;

FIG. 5 is a screenshot of a webpage displaying the interface to the software-based, IoT configuration tool as shown in FIGS. 1-4 , showing source code associated with the shield, a door/window sensor, a tilt sensor and a light switch, where lights are controlled by the state of the door/window sensor and/or the tilt sensor;

FIG. 6 shows an “associations” page associated with the screenshots shown in FIGS. 1-5 and automatically-generated source code based on one or more particular “Lifeline” associations;

FIG. 7 shows automatically-generated source code based on a selection of each association as shown in FIG. 6;

FIG. 8 shows a “defined rules” page associated with the screenshots shown in FIGS. 1-7 ;

FIG. 9 shows the defined rules page of FIG. 8 with several rules set up by a user in an “if-then-else” arrangement;

FIG. 10 is a simplified functional block diagram of a system for quickly developing new IoT products;

FIG. 11 is a conceptual framework of firmware operating on the IoT module shown in FIG. 1, coupled to the shield as shown in FIG. 1 for quickly developing new IoT products; and

FIG. 12 depicts a flow diagram illustrating one embodiment of a method, performed by the server or client computer shown in FIG. 10 for quickly developing new IoT products.

### DETAILED DESCRIPTION

Embodiments of the present invention allow engineers to quickly develop new IoT products without having to become experts in a variety of IoT protocols. “Quickly” means a range between 1 and 12 months rather than the typical 12 to 18 months required using prior art software tools. A software-based, IoT input configuration tool is described herein, which allows engineers to quickly design IoT devices, customize these devices and produce firmware to enable operation of each device. In some embodiments, both physical and software elements may be automatically generated. For example, a software-based, IoT configuration tool may provide schematics, board layouts, BOMs and source code to create a variety of IoT products.

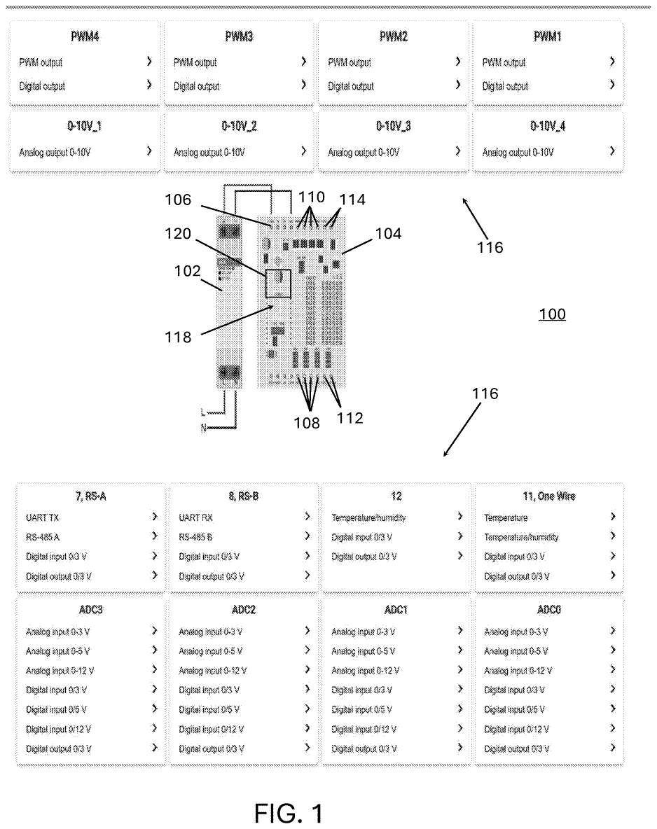

FIG. 1 is a screenshot of a webpage displaying one embodiment of an interface to a software-based, IoT configuration tool 100. Shown is a representation of an AC-to-DC converter (ADC) 102 and a representation of a “shield” 104 for use with an IoT module 120 that provides RF communications and processor-executable instructions associated with one of a number of populare IoT protocols. One such example is a Z-Uno Module, sold by Z-Wave. Me, which is inserted into an actual shield in area 118. The Z-Uno module comprises a proprietary Z-Wave. Me Z-Wave module (ZMExZUNOM) comprising a System-on-Chip (SoC) with integrated Z-Wave radio and processing power, allowing users to program it like an Arduino board (using C/C++) to create custom Z-Wave sensors, actors, and other IoT devices, fully compliant with Z-Wave Plus and S2 security. Shield 104 comprises a DC input 106 for receiving DC voltage from ADC 102 that powers the shield, a number of analog-to-digital (ADC) I/O 108, and a number of pulse-width modulation (PWM) outputs 110, digital outputs 112 and analog outputs 114. Each of the inputs and outputs are represented by selectable icons above and below ADC 102 and shield 104, as shown, each icon associated with an associated input or output. Each of the inputs and outputs may be configured by selecting one or more of the icons 116, which in turn may activate a number of drop-down menus, and selecting various, desired characteristics for each input or output. For example, each of the PWM outputs 110 comprise a selection between outputting a PWM output or a digital output. Each of the analog outputs allows selection of an analog voltage between 0 and 10 volts. Each of the ADC inputs allows selection of either an AC voltage input or a DC voltage input, and a range of allowable input voltages.

While the IoT configuration tool is shown in FIG. 1 as being used with shield 104, in other embodiments, the IoT configuration tool 100 may be used with a wide variety of other circuit board representations or even representations of integrated circuits, where inputs and outputs of the circuit boards or integrated circuits may be defined and configured automatically via IoT configuration tool 100.

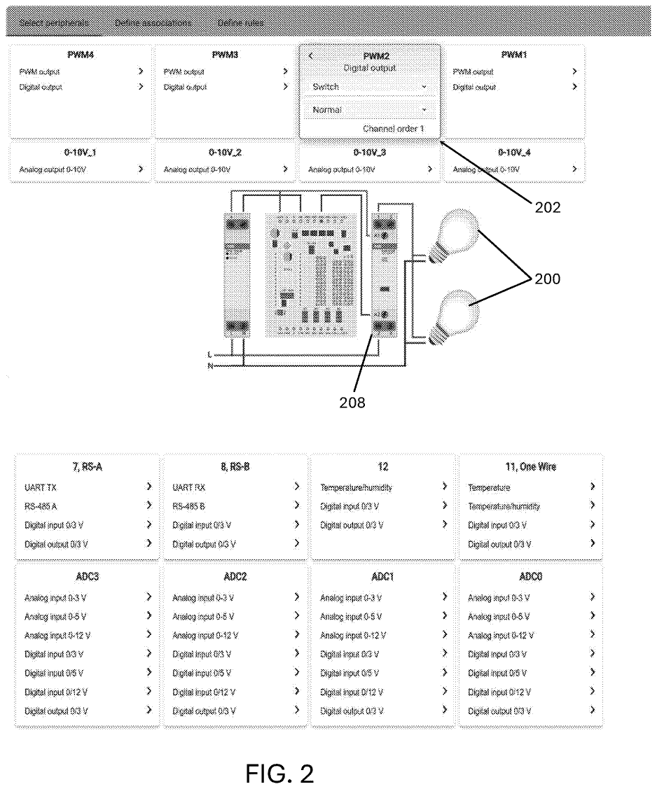

FIG. 2 is the same screenshot as FIG. 1, except that one of PWM outputs 110 has been selected as a digital output for controlling AC switch 208. AC switch 208, and two light bulbs 200, have been added to the representation shown in FIG. 2, showing how the particular output of PWM 110 is coupled to AC switch 208 and how AC switch 208 is coupled to light bulbs 200. Light bulbs 200 may be switched on and off when a desired input is received by shield 104, as will be described later herein.

While selection of one of PWM 110 outputs is shown as selection of a digital output for a switch, a user may select other types of devices for control by PWM outputs 110. For example, when the digital output option is selected by a user for one of PWM outputs 110, a drop-down menu 202 may appear, listing other potential devices for control by PWM2, such as a wireless door lock, a sensor, or any other electronic device that may be controlled digitally. As a result of selecting one of these other device types, a representation of a selected device may be shown in place of the light bulbs and/or AC switch 208 as shown in FIG. 2.

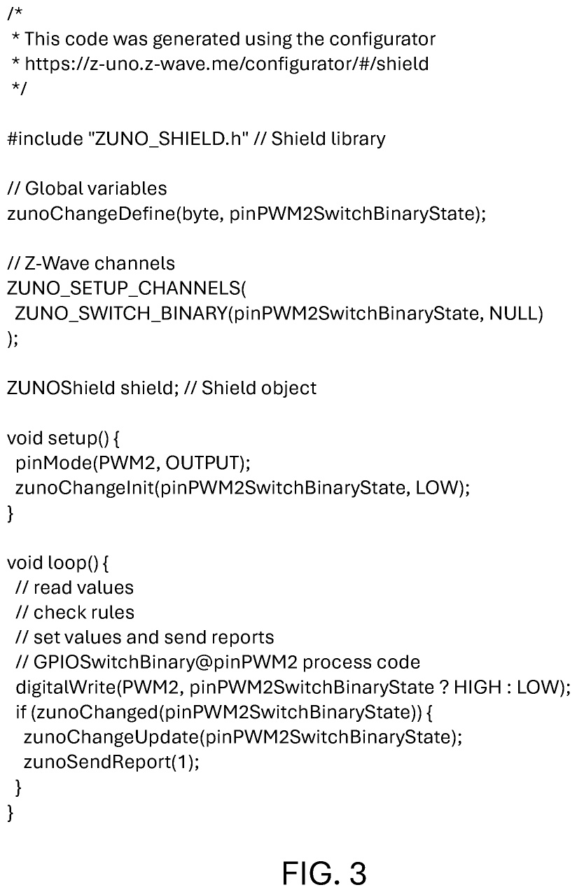

FIG. 3 is a source code listing that may be automatically generated as a user selects and configures various inputs and outputs of shield 104. In this embodiment, the source code comprises source code written in the “C” programming language however, in other embodiments, the source code may comport to one of a wide variety of other programming languages. In this embodiment, the source code comprises code that is generated depending on the selection and configuration of each pin of shield 104. In the example of FIG. 2, a digital output of PWM 110 was selected to control AC switch 208 which, in turn, controls one or more lights 200. The source code comprises an identification of global variables, protocol channels, setup associations, pin configuration, and code to control lights 200 depending on read values of various pins of shield 104 and user-defined rules for operating lights 200, which will be explained later herein.

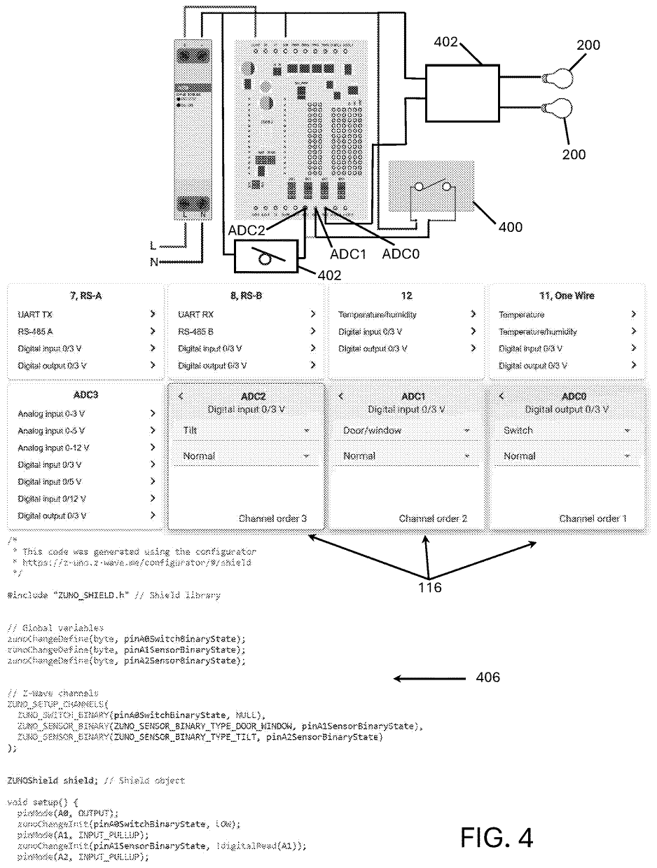

FIG. 4 is a screenshot of a webpage displaying the interface to software-based, IoT configuration tool 100 as shown in FIGS. 1-3, except that none of the digital outputs of PWM 110 are being used, two of the ADC I/O's 108 (ADC1 and ADC2) are being used to read two voltages of a reed switch of a door/window sensor 400 and a tilt switch, respectfully, and a third ADC I/O 108 (ADC0) is being used as a digital output for controlling light bulbs 200 via light switch 404. Tilt sensor 402 and door/window sensor 400 have been selected by a user of software-based, IoT configuration tool 100 from a number of potential choices of different hardware device types (not shown in this view) using the icons 116. When a particular device is selected for use with shield 104 using one of the configuration icons 116, a rendering of the selected device may be shown, in this case, switch 400, tilt sensor 402 and light switch 404. In one embodiment, when a device is selected via a configuration icon 116, a representation of the selected device may be shown on the display, in this case, door/window sensor 400, tilt sensor 402 and light switch 404, as well as lines representing wires connecting various inputs and outputs of shield 1042 each device. In one embodiment, a user may select a particular make and model of each device type, and the rendering may show actual pin numbers or connection points of each particular device in accordance with data sheets associated with each particular device. In one embodiment, a rendering is shown only for a particular device being configured. For example, when defining characteristics of ADC I/0 108 ADC1, only door/window sensor 400 may be rendered on the webpage.

As a result of selecting and configuring ADC I/0 108 ADC1, ADC2 and ADC3, the configuration tool may generate source code 406, partially shown at the bottom left of FIG. 4. Source code 406 may be generated based on selection of ADC I/0 108 ADC1 and ADC2 as digital inputs ranging in voltage 0-3 volts (ADC2) and 0-12 volts (ADC1), and ADC0 as a digital output, ranging in voltage from 0-3 volts. Source code 406 may comprise syntax from one of a number of possible programming languages, such as Zwave®, ZigBee®, etc. source code 406 may be generated from a number of pre-existing software templates, each module tailored towards a particular device type and, in some embodiments, a particular make and model of each particular device type. Each template may be populated by selected attributes, such as whether a pin is an input or an output, whether an analog or a digital signal is expected, a voltage range of expected inputs, etc.

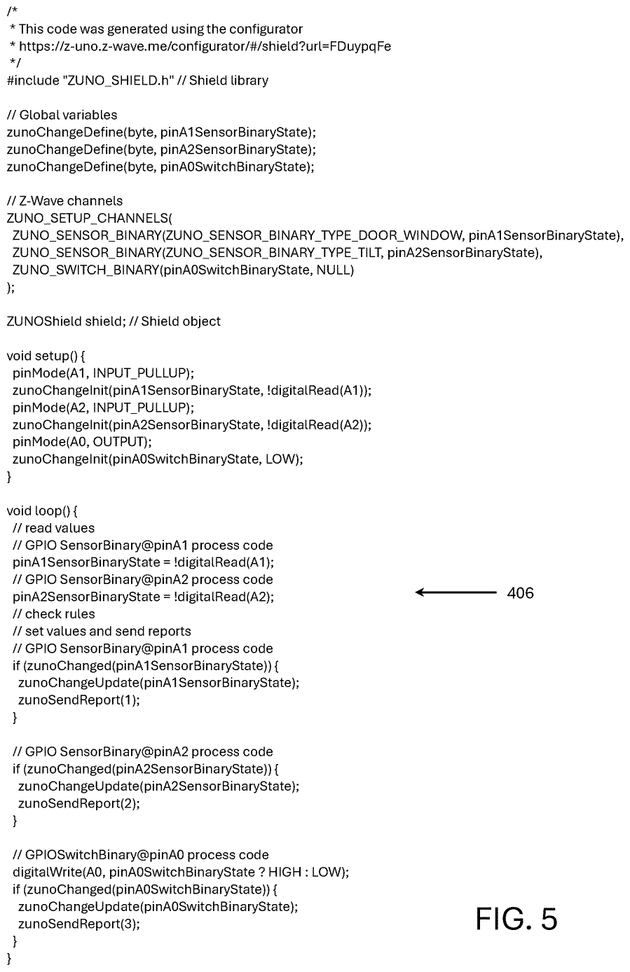

FIG. 5 is a screenshot of a webpage displaying the interface to software-based, IoT configuration tool 100 as shown in FIGS. 1-4 , showing source code 406 associated with shield 104, door/window sensor 400, tilt sensor 402 and light switch 404, where lights 200 are controlled by the state of door/window sensor 400 and/or tilt sensor 402. For example, when both door-window sensor 400 and tilt sensor 402 are in the “open” state, ADC1 and ADC2 read a voltage of approximately 0 and, as a result, software 406 may be configured to cause output ADC3 to remain at a digital low, close to 0 volts. Accordingly, lights 200 remain off. When digital “high” voltage is read at either ADC1 (indicating that door/window sensor 400 has changed state, i.e., a door or a window has been opened) or ADC2 (indicating that tilt sensor 402 has changed state, i.e., a garage door has been opened or closed) or both, software 406 may be configured to cause the voltage on digital output ADC3 to change from a digital 02 a digital one, i.e., in this example, a voltage of approximately 3 volts. In the example source code 406 in FIG. 5, digital inputs ADC1 and ADC2 and digital output ADC0 have been defined as global variables, assigned particular Z-wave channels, assigned as either an input, output or both, assigned an analog or digital type voltage, assigned a particular voltage range, etc. The remaining code comprises operating code of how each of ADC1 and ADC2 are read and how ADC3 changes state in accordance with the states of ADC1 and/or ADC2.

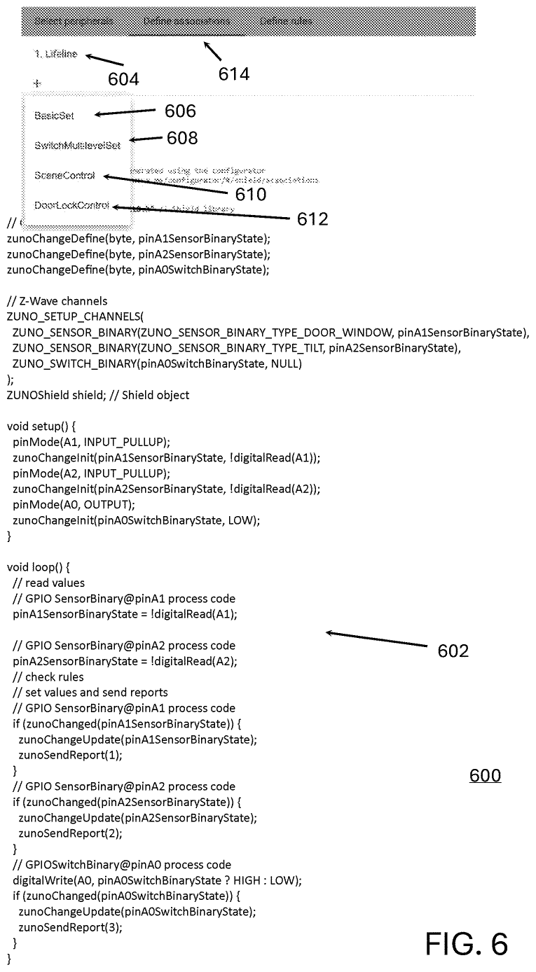

FIG. 6 shows an “associations” page 600 associated with the screenshots shown in FIGS. 1 through 5 and automatically-generated source code 602 based on one or more particular “Lifeline” associations. The associations page allows a user to add different associations for the devices associated with ADC I/0 108. Shown is a Lifeline association 604 selection, a BasicSet association 606 selection, a SwitchMultilevelSet association 608 selection, a SceneControl association 610 selection and a DoorLockControl association 612 selection as a “Define Associations” tab 614 is selected. In Z-Wave, “associations” refer to a direct link between two Z-Wave devices, allowing them to communicate with each other without needing to go through a hub. The Lifeline association in Z-Wave is a specific association group used for basic status updates. The SceneControl association refers to the ability of a device to trigger pre-defined scenes on other associated devices, essentially creating a direct “button-press” like action between devices without relying on a hub to interpret the command. The BasicSet association allows all devices in a defined group to receive commands or information when a certain event occurs, such as when a button is pressed or a sensor is triggered. The SwitchMultilevelSet association keeps all associated devices in sync with a device that transmitted a SwitchMultilevelSet command. The DoorLockControl association defines a relationship between a controller and a wireless door lock that allows commands from the controller to be sent to a wireless door lock. Of course, other associations may be defined and made available for selection by a user, and associations defined in wireless protocols other than Zwave.

Upon selection of a particular association, the source code 600 is automatically modified to create source code 602, which contains changes to implement each selected association.

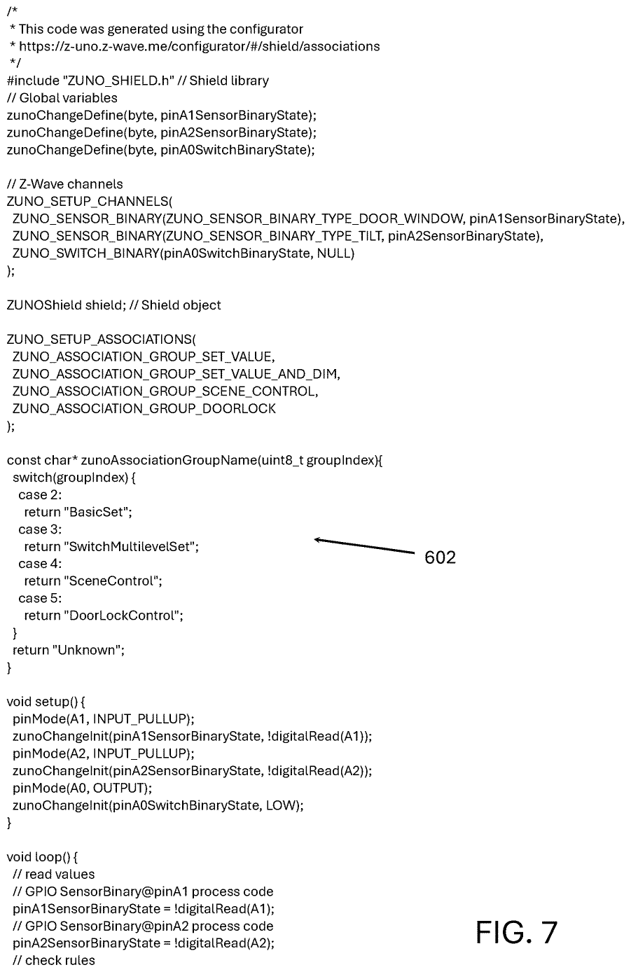

FIG. 7 shows automatically-generated source code 602 based on a selection of each association discussed above, i.e. the Lifeline association 604, the BasicSet association 606, the SwitchMultilevelSet association 608, the SceneControl association 610 and the DoorLockControl association 612. As one can see, source code 602 in FIG. 7 includes the additional associations selected in addition to the basic set association and source code 600 shown in FIG. 6.

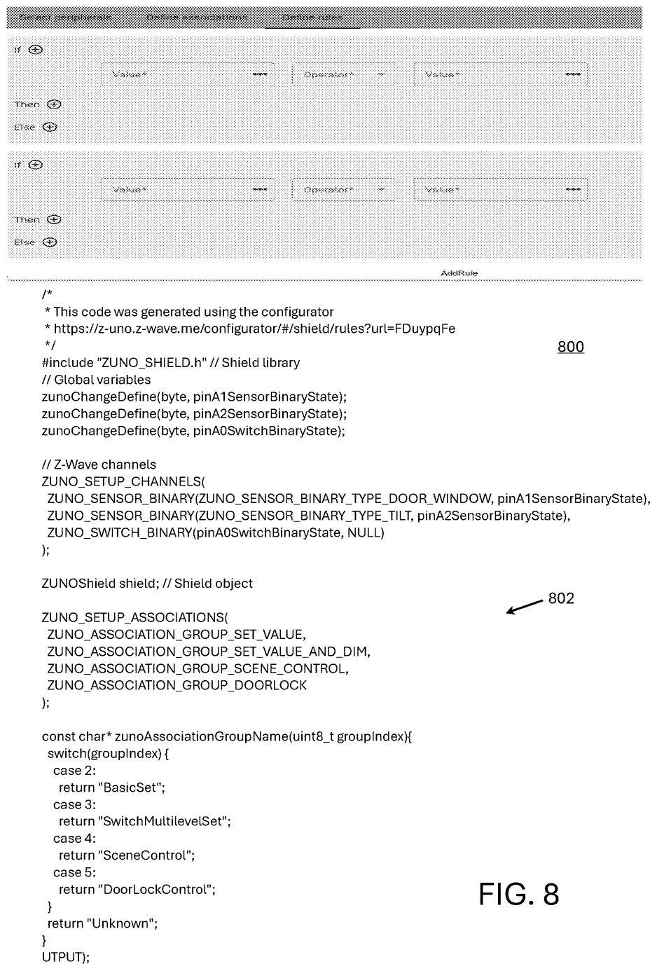

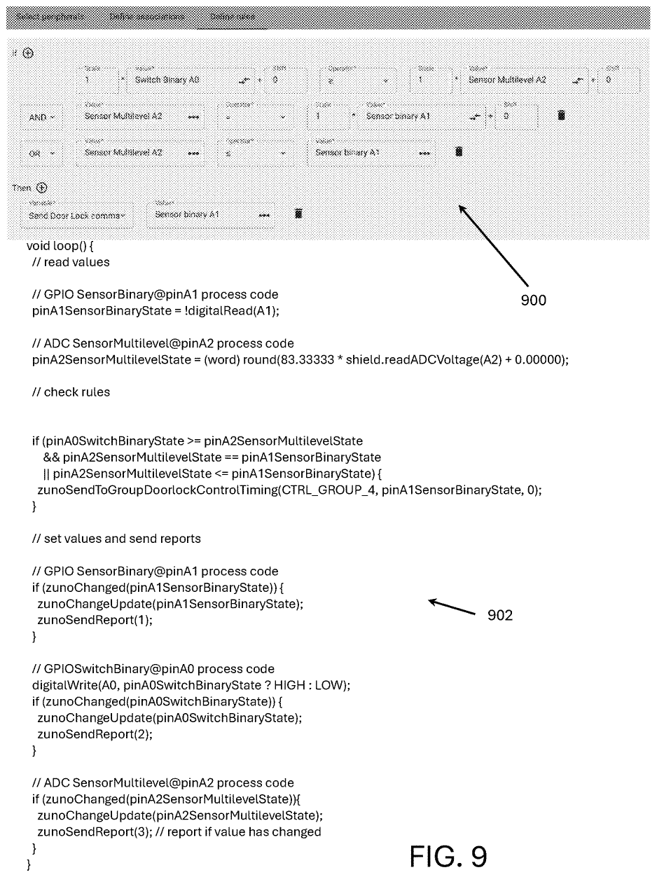

FIG. 8 shows a “defined rules” page 800 associated with the screenshots shown in FIGS. 1 through 7 and a partial display of automatically-generated source code 802 when no rules have been selected. The defined rules page 800 allows a user to control one or more devices based on inputs and outputs ADC I/0 108 of shield 104. The defined rules page allows wide flexibility in the types, ranges and combinations of logic operators to control various devices under development. For example, FIG. 9 shows the defined rules page with several rules 900 set up by a user in an “if-then-else” arrangement, showing how a door lock command is sent when the voltage on ADC I/0 108 ADC0 exceeds the voltage on ADC I/0 108 ADC2 and the voltage on ADC I/0 108 ADC2 equals the voltage on ADC I/0 108 ADC1. In selecting this particular logical arrangement, source code 600 is automatically altered to incorporate the logic, creating source code 902.

The software-based, IoT configuration tool 100 typically comprises computer executable instructions configured to automatically generate source code based on the selection and configuration of various capabilities of the shield (or circuit board, integrated circuit, etc.). In some embodiments, the software-based, IoT configuration tool 100 may additionally automatically provide other useful information, such as board layouts, BOMs, schematics, etc. The computer executable instructions may be stored in a memory of a server in the cloud and accessed by a client device through the Internet. In another embodiment, the computer executable instructions may be stored in a memory of a local computer, mobile device, etc. and executed by the local computer, mobile device, etc.

The source code for any particular arrangement may be generated as various inputs and outputs of shield 104 are selected, defined and configured. In some embodiments, sections of source code are stored in a memory and accessed as shield 104 is being defined. In this embodiment, as a processor receives the pin setup (i.e., selection, definition and configuration of input and outputs of shield 104), associations and/or rules from a user, it may analyze the selected pin setup, associations and/or rules to determine which code sections should be included in source code 602 presented to the user. For example, if ADC I/0 108 ADC1 is selected to receive a digital input between 0 and 5 volts from a door/window sensor and send a digital output signal ranging between 0 and 5 volts to a security siren on ADC I/0 108 ADC2, and the siren signal is only sent when ADC I/0 108 ADC3 is high (indicating, for example, that a security system is armed), then the processor of the server or local device may use this information to identify associated source code sections and configure each section with the relevant information, such as pin identification, input/output designation, analog/digital, voltage range, etc. The processor may also automatically generate source code logic based on representative source code stored in memory, to implement the logic defined on the rules page.

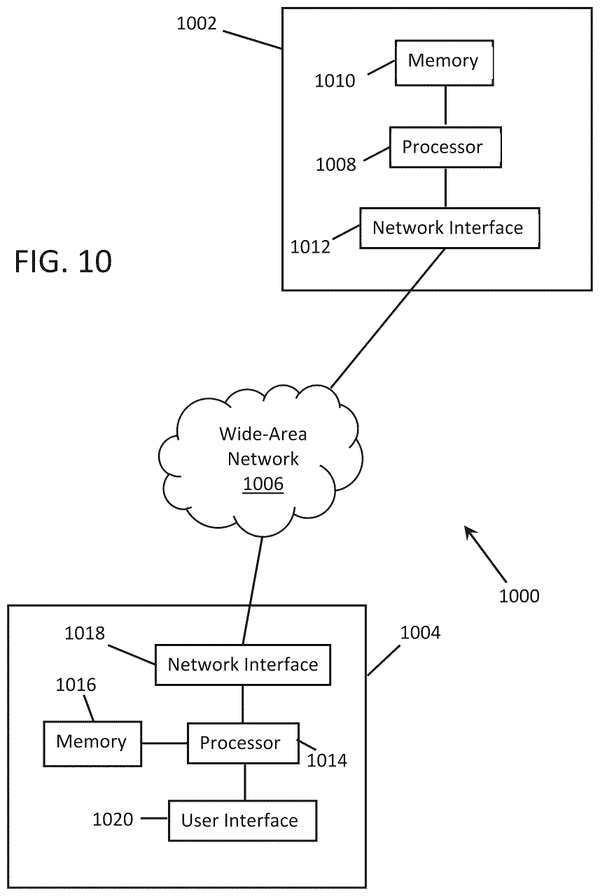

FIG. 10 is a simplified functional block diagram of a system 1000 for quickly developing new IoT products. Shown is a cloud-based computer 1002, a client computer 1004 and a wide-area network 1006. Cloud-based computer 1002 comprises processor 1008, non-transitory memory 1010, network interface 1012 while client computer comprises processor 1014, memory 1016, network interface 1018 and user interface 1020.

Each of processor 1006 and 1012 are configured to provide general operation of cloud-based computer 1002 and client computer 1004, respectively, by executing respective processor-executable instructions stored in memory 1010 and 1016, respectively, for example, executable computer code. Each of processor 1006 and 1012 comprises one or more general or specialized microprocessors, microcontrollers, and/or customized ASICs, selected based on computational speed, cost, power consumption, and other factors.

Each of memory 1010 and 1016 is coupled to processor 1008 and 1014, respectively, each comprising one or more non-transitory information storage devices, such as static and/or dynamic RAM, ROM, flash memory, or some other type of electronic, optical, or mechanical memory device. Each of memory 1010 and 1016 is used to store respective processor-executable instructions for operation of cloud-based computer 1002 and client computer 1004, respectively, including instructions to render wiring diagrams between various IoT devices and shield 104 and to generate source code for controlling one or more IoT devices. It should be understood that in some embodiments, a portion of each memory 1010 and 1016 may be embedded into each of processor 1006 and 1012, respectively and, further, that Each of memory 1010 and 1016 excludes propagating signals.

Each of network interface 1012 and 1018 is coupled to processor 1008 and 1014, respectively, each comprising circuitry for sending and receiving packetized data between client computer 1004 and cloud-based computer 1002 via wide-area network 1006. Wide-area network 1006 comprises one or more wired and/or wireless communication networks covering a large geographic area. Such communication networks comprise the Internet, cellular communication networks, satellite communication networks, etc.

User interface 1020 is coupled to processor 1014 and allows a user to communicate with processor 1014, such as to enter various commands and to view renderings and source code. User interface 1020 may comprise one or more pushbuttons, touchscreen devices, biometric readers, switches, sensors, keypads, and/or microphones that generate electronic signals for use by processor 1014 upon initiation by a user. User interface 1020 may alternatively, or additionally, comprise one or more seven-segment displays, a cathode ray tube (CRT), a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of resources to a user.

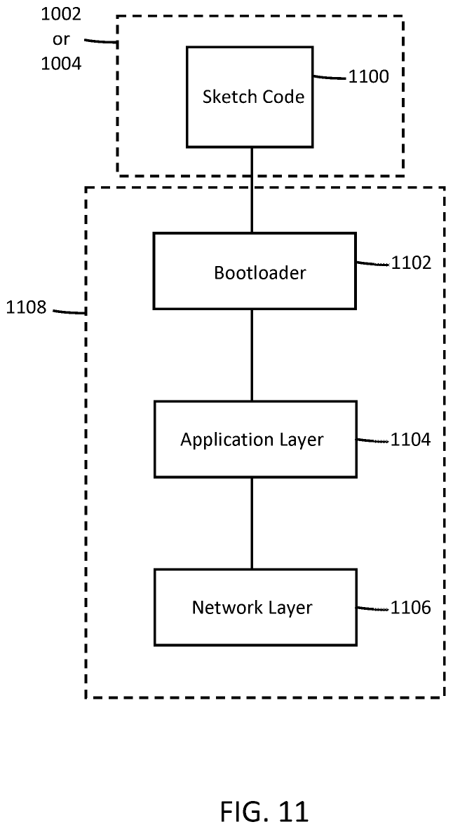

FIG. 11 is a conceptual framework of firmware 1108 operating on an IoT module 120 coupled to shield 104 for quickly developing new IoT products. Shown is sketch code 1100, bootloader 1102, application layer 1104 and network layer 1106. Sketch code 1100 originates from either server 1002 or client computer 1004 and is provided to bootloader 1102 via a wired communication interface, such as USB, UART, or others. Sketch code 1100 comprises a compiled version of any previously-described source code automatically generated by IoT configuration tool 100. In one embodiment, sketch code 1100 is generated in accordance with a simplified C programming language and loaded into the IoT module 120 after compiling using, for example, an Arduino IDE.

Sketch code 1100 may be compiled in accordance with one of several, common integrated developer environments, such as Arduino IDE, Raspberry Pi, etc. with additional core libraries installed. Similar to Arduino sketches, sketch code 1100 comprises firmware compiled for a corresponding microcontroller, such as one contained in the IoT module 120. Sketch code 1100 interact with the three other layers 1102, 1104 and 1106 via one or more libraries compiled together with a source version of sketch code 1100.

Bootloader 1102 receives the compiled sketch code 1100 and configures application layer 1104 in accordance with the pin setup, associations and/or rules listed in sketch code 1100. It may also handler service buttons to allow inclusion in an existing IoT network, such as a Z-Wave network or run in “rescue mode” and service LEDs to show a current state of the IoT module 120. Additionally, bootloader 1102 utilizes “callbacks” in sketch code 1100 on “Get” and “Set” packets originating from application layer 1104 as well as to run a loop when application layer 1104 or network layer 1106 is idle.

Application layer 1104 transforms portions of sketch code 1102 to binary code in accordance with a particular IoT protocol used by the IoT module 120. In one embodiment, portions of sketch code 1102 are transformed to comply with Z-Wave command classes in order to conform to a Z-Wave protocol. Application layer 1104 may also provide standard IoT features like firmware upgrades by air or by USB (OTA and OTW), AES encryption of radio packets, radio power metering, battery monitoring, wakeup configuration and basic information about the device itself.

Network layer 1106 handles network and radio layers for 2-way communications among other IoT devices. Network layer 1106 may calculate mesh network routes to reach destination devices, prepare and send radio packets and receive packets from other IoT devices.

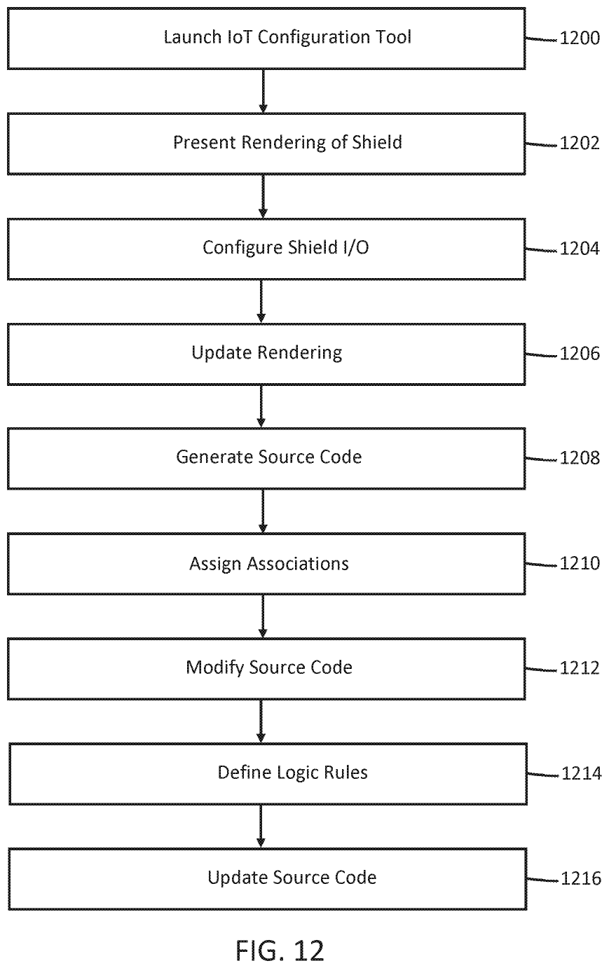

FIG. 12 depicts a flow diagram illustrating one embodiment of a method, performed by server 1002 or client computer 1004 for quickly developing new IoT products. More specifically, the method describes operations performed by processor in each server/computer, each executing processor-executable instructions stored in a respective memory. It should be understood that in some embodiments, not all of the steps shown in FIG. 12A-12B are performed, and that the order in which the steps are carried out may be different in other embodiments. It should be further understood that some minor method steps have been omitted for purposes of clarity.

At step 1200, a user of IoT configuration tool 100 launches tool 100 on client computer 1004 or on server 1002 via client computer 1004.

At step 1202, the user may be presented with an interface such as the one shown in FIG. 1 comprising a rendering of shield 104 and power supply 102.

At step 1204, the user may begin creating a new project to create a new IoT device by configuring one or more inputs and outputs of shield 104 by selecting one or more icons 126 and then selecting an IoT peripheral, such as lights 200, AC switch 208, tilt switch 402, door-window sensor 400, light switch 404, etc. in some cases, further user input is required in order to configure the inputs and outputs, depending on the peripheral(s) selected, such as whether an input or output digital or analog-based, a range of voltages, etc.

At step 1206, after the user has configured the inputs and outputs of shield 104 using one or more icons 126, the processor of either client computer 1004 or server 1002 may cause a rendering on user interface 1020, adding renderings of one or more of the peripherals selected by the user. In one embodiment, the renderings comprise references to a particular make and model of peripheral, as selected by the user, as well as references to inputs and outputs of each peripheral, as well as connection lines representing wired connections between various inputs and outputs of shield 104 and various inputs and outputs of each peripheral, as shown in FIG. 4. In an embodiment where particular makes and models of various peripherals are rendered, the memory of either client computer 1004 or server 1002 may store a library of potential peripheral devices, and for each peripheral device, a datasheet or other documentation indicating inputs and outputs and reference numerals identify each input and output.

At step 1208, the processor may automatically generate source code 406 associated with the IoT module 120 located on shield 104, depending on the peripheral type(s) and configuration of input and outputs of shield 104. The source code governs actions of the IoT module 120, including actions to operate the peripheral(s) based on certain conditions, sometimes sensed by one or more other peripherals coupled to the IoT module 120, such as door/window sensor 400, tilt sensor 402, etc.

At step 1210, the user may assign one or more associations between one of the peripherals selected by the user and another peripheral.

At step 1212, the processor may automatically modify the source code 406 based on the selected associations to produce source code 600. Source code 600 comprises code that causes the IoT module 120 to allow the selected peripheral and other peripheral to communicate directly with each other without having to communicate with a hub.

At step 1214, the user may define one or more logical rules to be applied by the IoT module 120 to one or more peripherals, input/outputs of shield 104, etc., as shown in FIG. 12.

At step 1216, the processor may automatically modify the source code 600 in order to incorporate the logical rules defined by the user in the previous step.

Appendix 1 is a data sheet describing characteristics of one embodiment of the IoT module 120, in this embodiment, a Z-Uno Module ZMExZUNOM sold by Z-Wave. Me.

Appendix 2 is a manual for using shield 104 in one embodiment of shield 104, in this example, a Z-Uno 2 shield.

In the description above, certain aspects and embodiments of the invention may be applied independently and some of them may be applied in combination as would be apparent to those of skill in the art. For the purposes of explanation, specific details are set forth in order to provide a thorough understanding of embodiments of the invention.

The above description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Although specific details are given to provide a thorough understanding of at least one embodiment, it will be understood by one of ordinary skill in the art that some of the embodiments may be practiced without disclosure of these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a method, a process or an algorithm performed by a processor, which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure.

The term “user” includes, but is not limited to, a person, a computer, a mobile smart device such as a mobile phone, tablet computer, wearable device, etc., an AI agent, an autonomous robotic platform, or some other non-human entity capable of requesting access to a resource. Similarly, the term “custom user attributes” includes, but is not limited to, attributes and conditions associated with a user, as defined in the preceding paragraph.

The terms “computer-readable medium”, “memory”, “storage medium”, and “information storage device” includes, but is not limited to, portable or non-portable electronic information storage devices, optical storage devices, and various other mediums capable of storing, containing, or carrying instruction(s) and/or data. These terms each may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, RAM, ROM, flash memory, solid state disk drives (SSD), etc. A computer-readable medium or the like may have stored thereon code and/or processor-executable instructions that may represent a method, algorithm, procedure, function, subprogram, program, routine, subroutine, or any combination of instructions, data structures, or program statements.

Furthermore, embodiments may be implemented by hardware, software, firmware, middleware, microcode, hardware description languages, or any combination thereof. When implemented in software, firmware, middleware or microcode, the program code, i.e., “processor-executable code”, or code symbols to perform the necessary tasks (e.g., a computer-program product) may be stored in a computer-readable or machine-readable medium. A processor(s) may perform the necessary tasks.

What is claimed is:

1. A method for quickly developing new IoT products, comprising:
receiving user selection of an IoT device type;
receiving pin setup information associated with a shield used in association with an IoT wireless module; and
automatically generating source code based on the selected IoT device type and the pin setup information for causing the IoT wireless module to control functions of the selected IoT product.

2. The method of claim 1, wherein the source code is generated in accordance with a first programming protocol different than a second programming protocol associated with the IoT wireless module.

3. The method of claim 2, further comprising:
receiving association information from the user, the association information comprising a selection of one of a plurality of association types offered in a menu of a user interface, each association type for allowing a direct link between two IoT devices, allowing them to communicate with each other directly without needing to use an IoT hub; and
automatically adding new source code to the source code that implements the selected association.

4. The method of claim 1, further comprising:
receiving rules information from the user, the rules information comprising a selection of one or more logical rules offered in a menu of a user interface in association with the selected IoT device; and
automatically adding new source code to the source code that implements logic rules associated with the rules information.

5. A server for quickly developing new IoT products, comprising:
a memory for storing processor-executable instructions;
a network interface; and
a processor coupled to the memory and to the network interface for executing the processor-executable instructions that causes the server to:
receive user selection of an IoT device type;
receive pin setup information associated with a shield used in association with an IoT wireless module; and
automatically generate source code based on the selected IoT device type and the pin setup information for causing the IoT wireless module to control functions of the selected IoT product.

6. The server of claim 4, wherein the source code is generated in accordance with a first programming protocol different than a second programming protocol associated with the IoT wireless module.

7. The server of claim 4, wherein the processor-executable instructions comprises further instructions that causes the server to:
receive association information from the user, the association information comprising a selection of one of a plurality of association types offered in a menu of a user interface, each association type for allowing a direct link between two IoT devices, allowing them to communicate with each other directly without needing to use an IoT hub; and
automatically add new source code to the source code that implements the selected association.

8. The server of claim 5, wherein the processor-executable instructions comprises further instructions that causes the server to:
receive rules information from the user, the rules information comprising a selection of one or more logical rules offered in a menu of a user interface in association with the selected IoT device; and
automatically add new source code to the source code that implements logic rules associated with the rules information.
